(19) United States
(12) Patent Application Publication
(10) Pub. No.: US 2013/0239476 A1
(43) Pub. Date: Sep. 19, 2013

(54) VEGETATED ROOF SYSTEM

(71) Applicant: MOLLY MEYER, LLC, Chicago, IL (US)

(72) Inventor: Molly Meyer, Chicago, IL (US)

(21) Appl. No.: 13/790,299

(22) Filed: Mar. 8, 2013

Related U.S. Application Data
(60) Provisional application No. 61/611,229, filed on Mar. 15, 2012.

(51) Int. Cl. A01G 1/00

(52) U.S. Cl. CPC A01G 1/007
USPC 47/65.9

(57) ABSTRACT

Embodiments of the present invention include a green roof system that includes a tray or array of trays designed to work in a drip irrigation system. The tray frame preferably has an open bottom covered by a filter fabric.

The present application claims priority to application Ser. No. 61/611,229 filed on Mar. 15, 2012, which is incorporated herein by reference.

### FIELD OF THE INVENTION

The disclosed embodiments relate to landscape architecture and more particularly deal with vegetated or green roof systems.

### BACKGROUND

There are generally several categories for green roof system designs including extensive green roofs, intensive green roofs, semi-intensive green roofs and comprehensive green roofs. An extensive green roof is lightweight (between 10 and 35 pounds per square foot) and usually planted with sedum. An intensive green roof is heavy (greater than 50 pounds per square foot) and planted as a lawn or with food crops or woody shrubs. A “semi-intensive” green roof is mid-weight (between 35 and 50 pounds per square foot) and often planted with native plants. A comprehensive green roof is lightweight (between 15 and 36 pounds per square foot), like extensive green roofs, and planted with a wide variety of plant options, including grasses, food crops, flowering perennials and woody shrubs, like intensive green roofs.

There are two categories for green roof system installations: built-in-place green roof systems and modular green roof systems.

Built-in-place green roof systems are typically comprised of the following layers (from roof deck and roof membrane up): root barrier, protection fabric or capillary fabric, drainage material or drainage channels, filter fabric, drip and/or spray irrigation, growing media, and plants. Built-in-place green roof systems are constructed by placing each layer one at a time, unrolling large rolls of fabrics, distributing large bags of growing media and planting individual plants, seeds or planted rolls (such as sod). There are modifications to the order of these layers and composition of each layer according to the design intent of the green roof space, i.e. extensive green roof which uses less growing media and different drainage components than a semi-intensive or intensive green roof. Designers using a built-in-place system have complete design flexibility between extensive, intensive and semi-intensive green roofs because of use of an irrigation system and the interchangeability of component layers.

Modular green roof systems are constructed by unrolling the root barrier or slip sheet and then hand-placing filled and planted trays like tiles. Typical tray sizes are 1′×2′, 18″×18″, 2′×2′ and 2′×4′ and are handheld by one or two laborers. Typical tray wall heights are 2″, 4″ and 6″. Some trays have walls that are made of a different material than the tray base; these walls are removable plastic sheets, removable plastic pieces or biodegradable paper. An empty tray often weighs 1 pound per square foot or more. Most modular green roof systems are used on extensive green roofs and cannot accommodate drip irrigation or spray irrigation that is supplied via subsurface tubing or piping.

While built-in-place green roof systems have more design flexibility than modular systems, built-in-place green roof systems are more costly to build on any structure other than on large roofs with easy crane access. Modular green roof systems are typically more efficiently built and used on all sized roof areas and roofs that are accessible by any method (including freight elevator, ladder, stairs or hoisting equipment).

To achieve both successful growth of plants and effective stormwater retention in green roof systems, whether built-in-place or modular, the green roof assembly preferably must self-regulate its water content. Too much water can mean the death of plants from root rot, disease and anaerobic conditions. So, water must be efficiently drained from a green roof during heavy storm events. However, some stormwater should be retained to slow the flow of water into the city's stormwater system, and some water should remain so that the plants can grow and survive through a drought. Irrigation systems on green roofs, coupled with efficient drainage, can achieve this balance of water needs for plants and stormwater needs for city stormwater programs.

### SUMMARY

Embodiments of the present invention include a green roof system that includes a tray designed to work in a drip irrigation system. The tray frame preferably has an open bottom covered by a filter fabric and optionally may support wall extensions.

In certain embodiments, a tray for a modular green roof system has a frame having sidewalls defining a substantially polygonal shape around an interior volume configured for holding growing media. The interior volume defines a bottom face between the sidewalls, and the frame defines an open space comprising at least a majority of the area of the bottom face. A filter fabric base is adjacent to the bottom face and configured to support a filter fabric which can be arranged to support growing media within the interior volume.

Optionally, a tray may include at least one brace extending across the bottom face, for example in a crossed shape which separates the bottom face area into four openings between the brace and said sidewalls. The filter fabric base may include extensions extending horizontally inward from the sidewalls to support the edges of a filter fabric, and may include openings are defined in a transition area between the sidewalls and the extensions to allow water to flow out from and into the tray.

In some embodiments, wall extensions are supported within the frame to increase the effective height of the sidewalls. In some arrangements the wall extensions are self-supporting within the tray interior. Alternately, the wall extensions are removably held in place within the tray interior, for example on tabs extending horizontally inward from said sidewalls.

In some embodiments, an arrangement of trays is provided for a modular green roof system. A plurality of adjacent trays are arrangeable on an underlying structure each having a frame. Each frame has sidewalls defining a substantially polygonal shape around an interior volume configured for holding a growing media. The interior volume defines a bottom face between the sidewalls. Each frame defines open space comprising at least a majority of the area of the bottom face. The sidewalls include lower vertical sidewall portions spaced inward towards the interior of each tray relative to upper sidewall portions. The inward spaced distances of the sidewall portions of adjacent trays define covered channels between adjacent trays. Irrigation tubing is arranged in at least one of the covered channels. In some optional embodiments, the frames are substantially rectangular in shape, and the trays are arrayed on an underlying structure in an arrangement of parallel rows and columns.

Other objects and advantages of embodiments of the present invention are apparent from the description, figures and claims.

### BRIEF DESCRIPTION OF THE DRAWING

FIG. 1 is a top perspective view of a tray arrangement according to one embodiment of the disclosure.

FIG. 2 is a lower perspective view of the tray arrangement of FIG. 1.

FIG. 3 is a side view of the tray arrangement of FIG. 1.

FIG. 4 is an exploded view of the tray arrangement of FIG. 1 with a filter material and growing media.

FIG. 5 is a perspective view of the tray arrangement of FIG. 1 with an example wall extension arrangement.

FIG. 6 is a perspective view of a modular roofing system incorporating tray arrangements according to embodiments herein.

FIG. 7 is a side view of the modular roofing system of FIG. 6.

FIG. 8 is a perspective view of the tray arrangement of FIG. 1 with an example mounting of a wall extension arrangement.

FIG. 9 is a perspective view of the tray arrangement of FIG. 1 with an alternate example mounting of a wall extension arrangement.

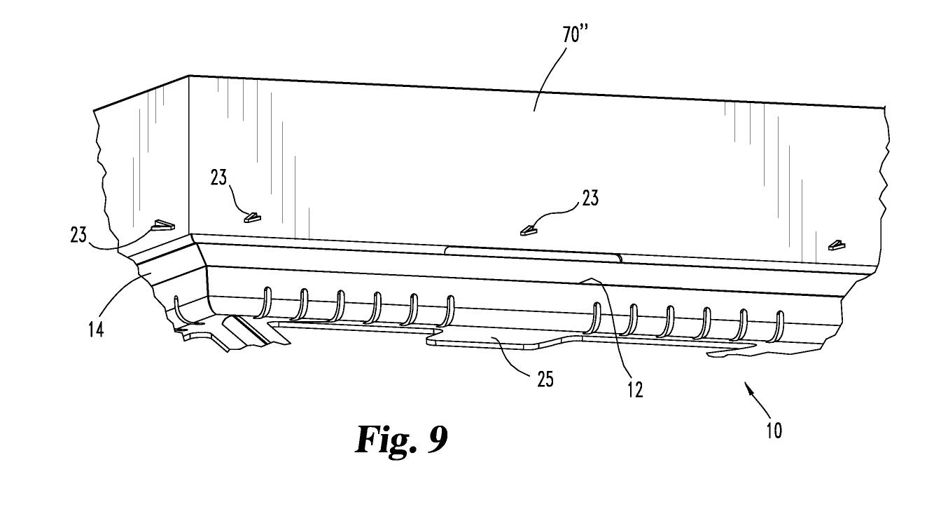

FIG. 10 is a perspective view of the tray arrangement of FIG. 1 with an example tray sleeve arrangement.

### DETAILED DESCRIPTION OF THE ILLUSTRATED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is thereby intended, such alterations and further modifications in the illustrated device, and such further applications of the principles of the disclosure as illustrated therein, being contemplated as would normally occur to one skilled in the art to which the disclosure relates.

Embodiments of the present invention include a modular or built in place green roof system that includes a tray designed to work in a drip irrigation system. The tray frame preferably has an open bottom covered by a filter fabric and optionally may support wall extensions.

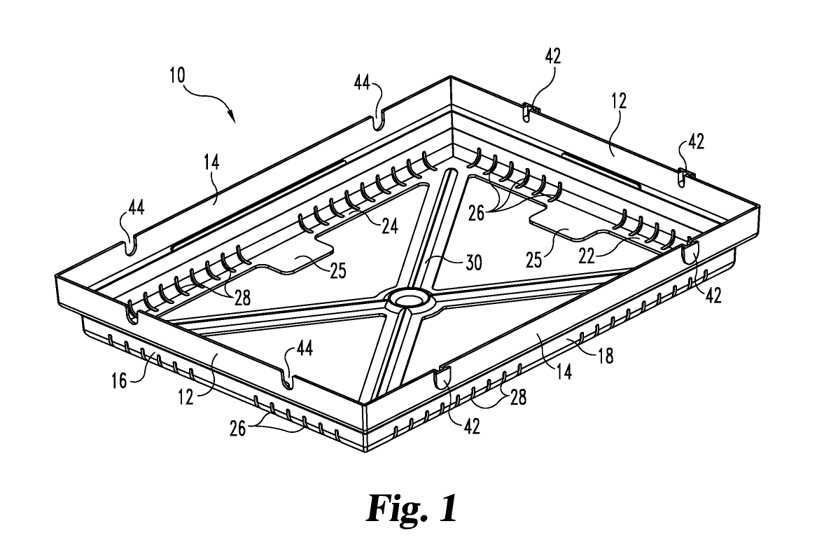

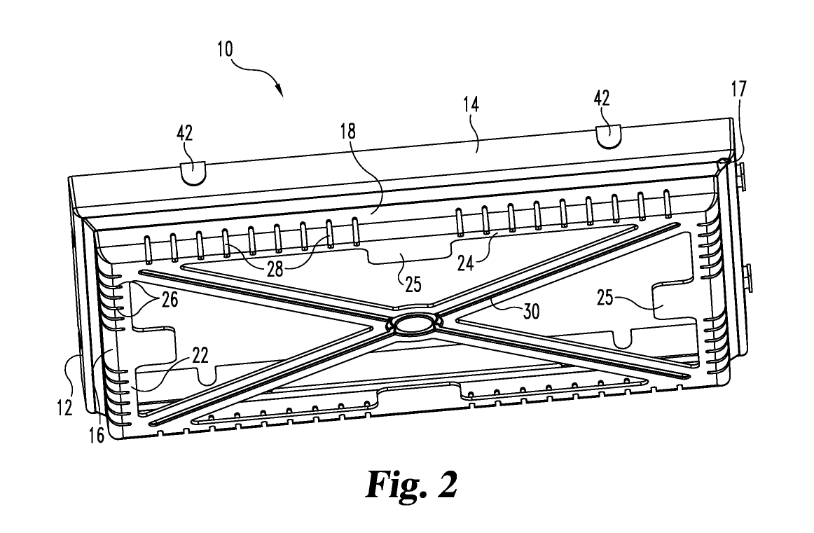

An example embodiment of a tray is illustrated in FIGS. 1-3. The illustrated tray 10 is substantially rectangular, for example 12″ wide, 16″ long, and 2″ tall. Other shapes such arcuate or polygonal shapes may alternately be used. Example tray 10 is formed by a frame having two shorter sidewalls 12 and two longer sidewalls 14, although the dimensions may be altered as desired. The frame sidewalls form a periphery surrounding an interior volume configured for holding growing media. Tray 10 is, for example, formed of a solid, typically rigid plastic or aluminum frame. Alternately, a biodegradable or biodegradable coir material can be used. Preferably, multiple trays 10 are interchangeable in a modular roof arrangement.

The bottom face of the interior volume of tray 10 between the sidewalls is largely an open void area, yet may include braces 30 that provide structural support for the rectangular frame and a partial base for a filter fabric to rest upon to hold growing media in the tray. Generally, the open space portion comprises a majority and preferably a substantial majority, such as at least sixty percent, of the area of the bottom face. In certain embodiments, the open space comprises at least three-quarters of the area of the bottom face.

Illustrated braces 30 are shown in a crossed or X-shape. Alternately, braces or bracings in a grid, striped, radial, inward extension or other pattern could be used. When bracing is used, at least a majority and preferably a substantial majority of the bottom face area remains open.

A flange or lip extends horizontally inward from each sidewall, such as extensions 22 from walls 12 and extensions 24 from walls 14. The extensions are relatively short, for example extending approximately one-quarter inch (¼″) inward from the respective sidewalls. Extensions 22 and 24 define a base to support the edges of a filter fabric to rest within the tray. Sidewalls 12 and 14 optionally define handle portions 25 extending into the middle bottom of tray 10 so that workers lifting a tray filled with growing media do not disrupt the filter fabric, which could potentially cause growing media to spill from the bottom of the tray.

Optionally yet preferably, the edges or transition area between sidewalls 12 and 14 and extensions 22 and 24 define slots 26 and 28, perforations or similar openings, to allow water to flow out from and into the tray. For example, the slots may be one-eight inch (⅛″) wide and one-half inch (½″) on center.

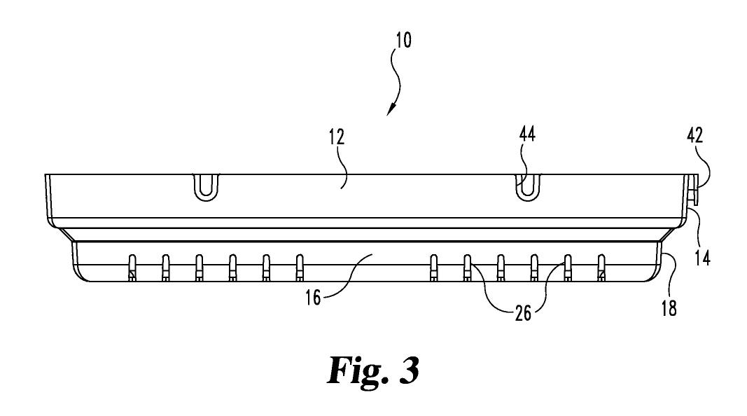

As illustrated in detail in FIG. 3, in certain embodiments sidewalls 12 and 14 include lower vertical sidewall portions 16 and 18 which are spaced inward or towards the middle of tray 10 relative to the vertical upper sidewall portions. The inset or inward spaced distances of the lower sidewall portions define channels between adjacent trays. When two trays are placed immediately next to one another, the spaces may act as covered drainage channels and/or a housing for irrigation tubing/piping. Tubing/piping may be made of a flexible or rigid material. Preferably, the inward spacing of the adjacent lower sidewall portions is sized to receive irrigation tubing within the covered channel without applying pressure which could inhibit water flow to, from or within the tubing, such as by pinching, squeezing or binding the tubing. The transition from the upper sidewall portions to lower sidewall portions 16 and 18 is optionally tapered. The base portions of lower sidewall portions 16 and 18 may transition into inward horizontal extensions 22 and 24.

Optionally, tray 10 may include locking mechanisms to engage adjacent trays. For example, tray 10 may include male connectors 42 along one shorter side and one longer side, and female connection openings 44 along one shorter side and one longer side. As adjacent trays are placed next to one another, these male-female joints may be connected to lock adjacent trays in place. Alternate locking mechanisms such as alternate shaped engaging tab slots, overlapping lips or grooves/channels, or individual fasteners may alternately be used.

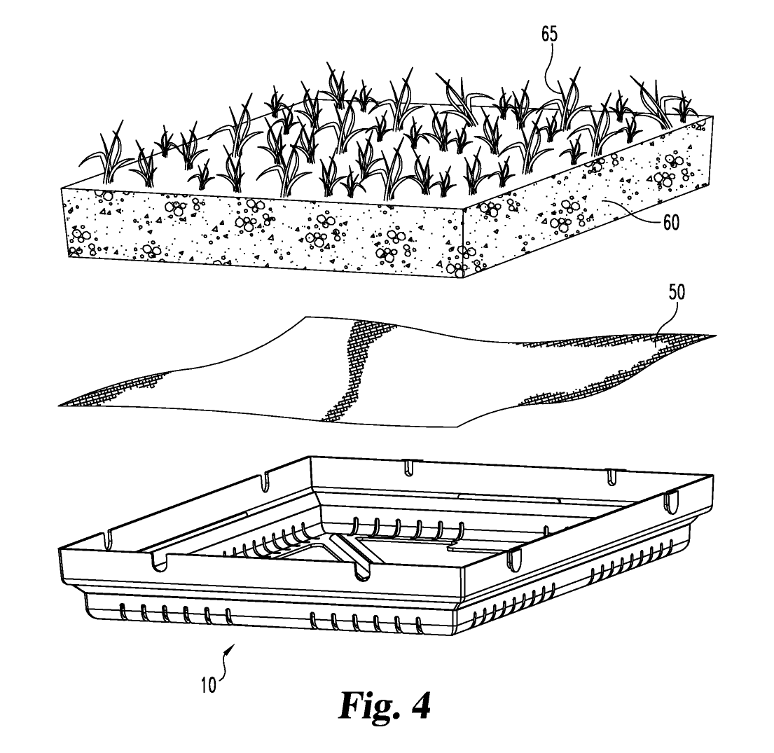

As illustrated in FIG. 4, a tray 10 is typically used by arranging a filter fabric 50 across the bottom face of the interior volume of tray 10, covering or at least substantially covering the openings. In certain embodiments, the filter fabric is a non-woven geotextile, with a weight between 50 and 200 grams/square meter, depending on the application. A non-woven geotextile is a fabric comprised of polypropylene, polyester or blended materials.

Fabric 50 may be supported in tray 10 with the edges overlapping extensions 22 and 24 and by lying over support braces 30. In one embodiment, fabric 50 is loosely laid in place, while alternately fabric 50 may be secured and retained in place using retention mechanisms or fasteners such as spikes which penetrate or grab the fabric, adhesive or clips. Once fabric 50 is in place, growing media 60 is arranged in the interior area of tray 10 by placing and spreading it over fabric 50. The weight and volume of growing media 60 may assist to hold fabric 50 in place. The growing media 60 may be pre-planted with seeds or growing plants 65, yet alternately seeds or plants may be placed in the growing material after it is placed within tray 10.

Often, when a modular system is being emplaced, the tray may be filled and pre-planted in a green house. Alternately, if a built-in-place system is being constructed, then the trays are placed on the roof and the trays are overfilled with growing media to achieve a desired depth, and the growing media is then planted in situ.

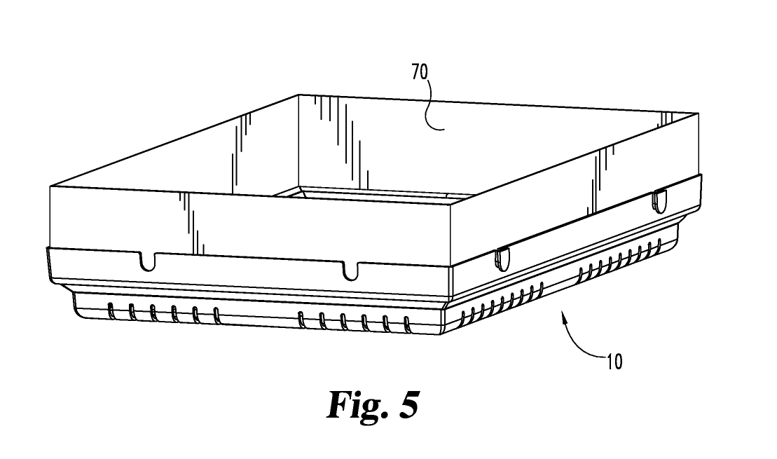

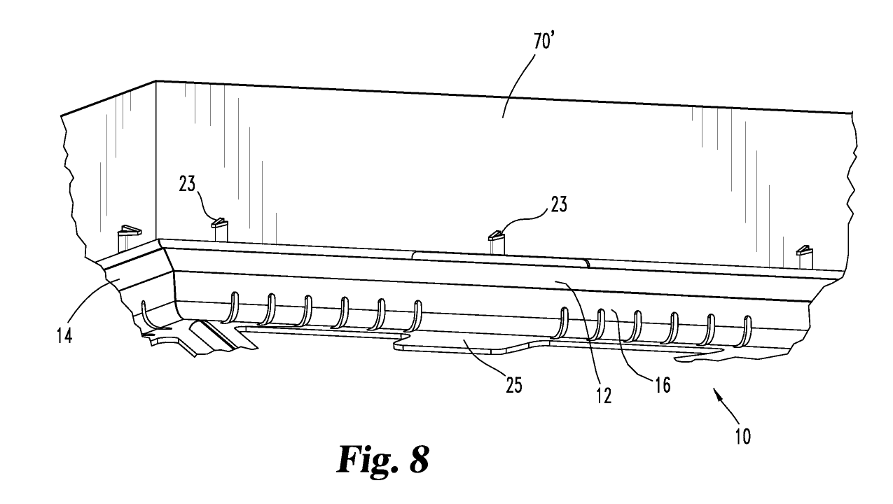

Optionally, tray 10 may support the use of wall extensions 70 as illustrated in FIGS. 5, 8 & 9. Wall extensions preferably increase the effective height of the sidewalls of tray 10, for example wall extensions 70 of two, four or seven inches in height may allow tray 10 to support growing media 60 in effectively a three inch side walled, five inch side walled or eight inch side walled arrangement. The wall extensions may be made of biodegradable, compostable and/or recyclable plastic or biodegradable, compostable and/or recyclable fiberboard (depending on customer preference). The biodegradable or compostable wall extensions are typically left in place when the trays are placed on the roof. Over time the wall extensions degrade, and the growing media will then contact and may merge with the growing media in an adjacent tray. Alternately, recyclable or non-degradable wall extensions are removed when the trays are placed on the roof, allowing the growing media in adjacent trays to be in immediate contact.

If a modular system is being constructed, the wall extensions are mounted to the trays before being filled with growing media, for example during an assembly process at a greenhouse. In such arrangements, the growing media is added to the trays after the wall extensions are placed within them, in order to achieve desired media depth.

Examples of compostable wall extension materials include a high-density polyethylene film or extrusion sheet. Two commercially available compostable films and sheets are sold under the names Ingeo Biopolymer 4043D from NatureWorks, LLC and Tundra HD from Contract Converting, LLC. Examples of a biodegradable plastic film or extrusion sheet include two commercially available biodegradable films and sheets sold under the names Mirel by Telles and SoilWrap by Ball Horticultural Company. Alternately, the wall extensions can be formed from a biodegradable fiberboard from molded pulp such as Plantable Packaging by UFP Technologies. Still further examples include a recyclable plastic film or extrusion sheet or a recyclable paper or fiberboard.

In certain preferred embodiments, the wall extension 70 may be self-supporting such as a rectangular frame within the tray's periphery, a piece bent into an “L”-shape or a corrugated sheet. Alternately, one or more pieces may form individual sidewalls. In certain embodiments, the wall extensions are held upright and in place against sidewalls 14 and 16 by the volume and outward pressure of the growing media 60 placed within tray 10. Alternately, tray 10 may include mechanisms to assist in holding the wall extension pieces in place. For example, the extensions may be removably held in place using tacking adhesive or Velcro® style hoop and loop fasteners. In alternate embodiments, the tray could define a groove, channel or lip in a lower sidewall or an extension portion which can retain the lower edge of a sidewall extension.

In still further embodiments for example as illustrated in FIGS. 8 & 9, the tray wall may incorporate fasteners or tabs 23, for example horizontal inward pointing tabs/spikes that allow wall extensions 70′ with pre-formed or formed-at-will slots in the wall extensions to be pushed downward so that the horizontal tabs slide 23 upward into the slots and hold the wall extension. Alternately, wall extensions 70″ may be pushed sideways onto a tab/spike forcing a tab/spike 23 to penetrate and then holding the wall extensions in place. In still further embodiments, vertical tabs, spikes or the sidewalls may define a channel or lip into which the lower edge of the sidewall extension can be slid and/or wedged.

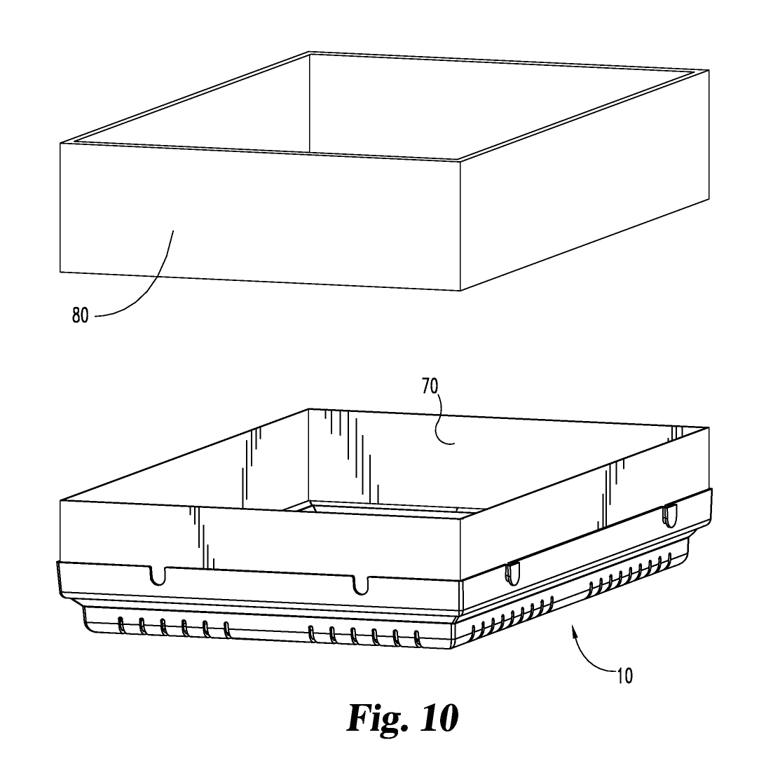

Separately, but typically in conjunction with wall extensions as illustrated in FIGS. 5, 8 & 9, optionally a tray sleeve 80 may be used with a tray arrangement, as illustrated in FIG. 10. Tray sleeve 80 may be formed in a polygonal frame shape matching the shape of tray 10, discussed herein with the example of a rectangle. Tray sleeve 80 defines an four-walled frame having an interior width and an interior length matching the exterior width and exterior length of tray 10, enabling tray sleeve 80 to either be placed around the periphery of tray 10 and supported on the same surface or placed around the periphery of wall extensions 70 and supported by the perimeter of tray 10. Although typically used with wall extensions, tray sleeve 80 may be used without wall extensions, for example to isolate a tray while filling it with growth media and plant matter. When used with wall extensions 70 and tray 80 sleeve is resting on the same surface as the tray, the height of tray sleeve 80 preferably is approximately equal to the effective height of tray 10 plus the wall extensions, for example a three inch side walled, five inch side walled or eight inch side walled arrangement. Alternately, when used with wall extensions 70 and resting on the perimeter edges of the tray, the height of tray sleeve 80 preferably is approximately equal to the effective height of the wall extensions above the tray, for example a one inch side walled, three inch side walled or six inch side walled arrangement

In certain embodiments, tray sleeves 80 are placed around a tray and wall extensions to provide rigidity and to assist in supporting the wall extensions and enclosed growing media. Tray sleeves may be made from a non-biodegradable material, and may be rigid or flexible, for example they can be made from a semi-rigid plastic sheet or extruded plastic material. Tray sleeves 80 may help to protect and support biodegradable wall extensions, for example if trays are planted using wall extensions in advance of installation, and where the biodegradable wall extensions may or could begin to degrade before installation due to moisture, damage or the passage of time. Tray sleeves 80 may be set in place around trays for initial planting, initial growth and/or transport, and are then typically removed once the trays are in place. Alternately, a tray sleeve 80 can be placed around a tray after an initial planting, for example when it is realized that there may be a delay between planting and installation. In alternate embodiments, a tray sleeve may be formed from a biodegradable material, such as a fiberboard or corrugated cardboard.

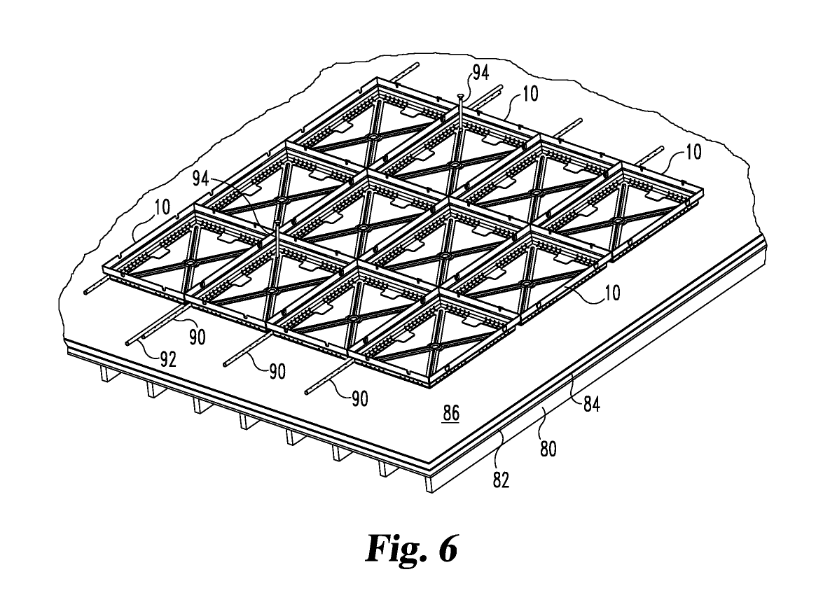

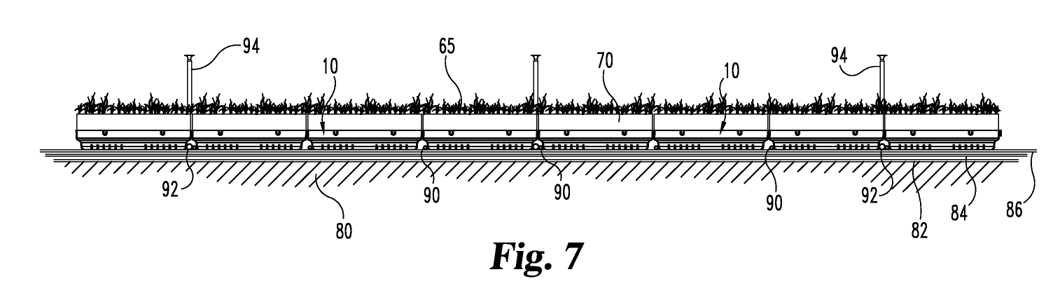

FIGS. 6 and 7 illustrate an arrangement of a vegetated roof system using multiple trays 10. In the illustrated arrangement the system is supported by an underlying structure 80, typically a roof. A waterproof membrane 82 is arranged across the upper surface of the roof, over which is the arranged a root barrier or slip sheet 84 and then a capillary fabric 86. Preferably, one or more trays 10 are arranged over the capillary fabric 86 as desired. Trays 10 are illustrated in a row and column layout, but alternate geometric arrangements can be used as desired for functional or aesthetic arrangements. Optionally yet preferably, when trays are arranged side-by-side, they engage and lock together to substantially eliminate any gaps between the upper sidewalls of adjacent trays. The trays are typically filled with filter fabric and growing media in advance, but alternately can be filled after being arranged in place to form a built-in-place arrangement.

The illustrated arrangement incorporates an irrigation or water supply arrangement to provide water to growing media within the trays. For example, drip irrigation tubing, can be used which is typically supplied in one-quarter inch (¼″), one-half inch (½″) or three-quarter inch (¾″) diameters. The tubing is laid in parallel rows across a roof surface, generally perpendicular to the roof slope and between adjacent rows of trays. In one example of installation, one row of trays is placed on the capillary fabric; the irrigation tubing is then unrolled and slid under and against a lower sidewall portion such as sidewall portion 18, along that row of trays. Then, a second row of trays is placed adjacent to the first row of trays with the upper sidewall portions covering the rest of the irrigation tubing. The covered channel created by the lower sidewall portions of two adjacent trays holds the irrigation tubing in place.

Without limitation, drip irrigation tubing is typically spaced either 12″ on center or 16″ on center on green roof applications. The example embodiment of a 12″×16″ tray thus accommodates two spacing options for drip irrigation tubing. The void spaces not used for irrigation tubing, primarily the perpendicular channels along lower sidewall portions 16, are parallel to one another and are parallel to the roof slope. These void spaces act as drainage channels through which surplus water can efficiently flow out of the green roof assembly to the roof drains.

In use, the water supply arrangement supplies water through the drip irrigation tubing which then discharges the water in the channels between rows of adjacent trays. The slots, fabric and open bottoms within the trays allow water to flow into the trays and to reach the growing media either directly, via seepage or via capillary action. Excess water, from rain or over-watering, can flow out of the trays through the slots, fabric and open bottom and can flow through drainage channels to a roof drain or other drainage system.

In certain optional embodiments, the irrigation system may incorporate overhead spray accessories such a sprinkler heads 94. If sprinklers are used, water supply pipes 92 are arranged between rows of adjacent trays in the channels defined by the lower sidewalls. The water supply pipes may be dual function where they are sufficiently pressurized to support spray accessories while also functioning as drip irrigation tubing, but typically are separate yet parallel. Periodically, a sprinkler head 94 extends perpendicularly upward from a water supply pipe 92 to a height above the trays. When activated, water supplied through pipes 92 is pumped to sprinkler heads 94 and sprayed onto the growing media and plants in one or more trays. In certain embodiments, the sidewalls of trays 10 may include a notched or indented corner to allow for passage of a sprinkler head through a single notch or through a space defined by adjacent notches. Alternately, each tray may have an opening or a portion removable to form an opening through which a sprinkler head may extend upward, such as through knock-out opening 17.

While the illustrated embodiments have been detailed in the drawings and foregoing description, the same is to be considered as illustrative and not restrictive in character, it being understood that only the preferred embodiment has been shown and described and that all changes and modifications that come within the spirit of the invention are desired to be protected. The articles “a”, “an”, “said” and “the” are not limited to a singular element, and include one or more such elements.

1. A tray for a modular green roof system, comprising:
a frame having sidewalls defining a substantially polygonal shape around an interior volume configured for holding growing media;
said interior volume defining a bottom face between the sidewalls, said frame defining an open space comprising at least a majority of the area of said bottom face;
a filter fabric base adjacent said bottom face configured to support a filter fabric, which can be arranged to support growing media within said interior volume.

2. The tray of claim 1, wherein said open space comprises more than sixty percent of the area of said bottom face.

3. The tray of claim 1, wherein said open space comprises at least three-quarters of the area of said bottom face.

4. The tray of claim 1, comprising include a least one brace extending across said bottom face to support said filter fabric.

5. The tray of claim 4, wherein said at least one brace forms a crossed shape extending across said bottom face and separating the area of said bottom face area into four openings between said brace and said sidewalls.

6. The tray of claim 1, wherein said filter fabric base comprises extensions extending horizontally inward from said sidewalls to support the edges of a filter fabric.

7. The tray of claim 6, wherein openings are defined in a transition area between said sidewalls and said extensions to allow water to flow out from and into the tray.

8. The tray of claim 1, wherein said filter fabric base incorporates retention mechanisms to secure a filter fabric in place.

9. The tray of claim 1, wherein said sidewalls include lower vertical sidewall portions inwardly spaced towards the interior of the tray relative to upper sidewall portions.

10. The tray of claim 9, comprising an adjacent tray having an adjacent sidewall which includes a lower vertical sidewall portion inwardly spaced towards the interior of the tray relative to an upper sidewall portion, wherein the inward spacing of the adjacent lower sidewall portions defines a covered channel between said adjacent trays.

11. The tray of claim 10, wherein the inward spacing of the adjacent lower sidewall portions is sized to receive an irrigation tube within said covered channel without inhibiting water flow.

12. The tray of claim 1, comprising wall extensions supported within said frame to increase the effective height of said sidewalls.

13. The tray of claim 12, wherein said wall extensions are self-supporting within said tray interior.

14. The tray of claim 12, wherein said wall extensions are removably held in place within said tray interior.

15. The tray of claim 12, wherein said wall extensions are mounted on tabs extending horizontally inward from said sidewalls.

16. An arrangement of trays for a modular green roof system, comprising:
a plurality of adjacent trays arrangeable on an underlying structure each having a frame;
each frame having sidewalls defining a substantially polygonal shape around an interior volume configured for holding a growing media, said interior volume defining a bottom face between the sidewalls, each frame defining open space comprising at least a majority of the area of said bottom face;
said sidewalls including lower vertical sidewall portions spaced inward towards the interior of each tray relative to upper sidewall portions, wherein the inward spaced distances of sidewall portions of adjacent trays define covered channels between adjacent trays; and,
irrigation tubing arranged in at least one of said covered channels.

17. The arrangement of claim 16, wherein said sidewalls define openings to allow water to flow out from and into the trays.

18. The arrangement of claim 16, wherein said frames are substantially rectangular in shape.

19. The arrangement of claim 18, wherein said plurality of trays are arrayed on an underlying structure in an arrangement of parallel rows and columns.

20. The arrangement of claim 16, comprising filter fabric arranged across the bottom face in each tray to support growing media within each said interior volume.
